(19) United States
(12) Patent Application Publication
(10) Pub. No.: US 2012/0047433 A1
(43) Pub. Date: Feb. 23, 2012

(54) Document Reviewer System

(76) Inventors: John E. Nemazi, Bloomfield Hills, MI (US); James W. Proscia, Canton, MI (US)

(21) Appl. No.: 13/213,610

(22) Filed: Aug. 19, 2011

Related U.S. Application Data
(60) Provisional application No. 61/375,572, filed on Aug. 20, 2010.

(51) Int. Cl. G06F 17/21

(52) U.S. Cl. 715/251

(57) ABSTRACT

A computer system for reviewing electronic documents is provided. The system comprises a computer processor implementing a method including sequentially displaying documents from the ordered list of documents on a monitor. The documents are displayed by automatically displaying pages from a user selected document in the ordered list in a page-by-page manner. After display of the last page of the user selected document, pages from the next document are automatically displayed in the ordered list in a page-by-page manner.

### CROSS-REFERENCE TO RELATED APPLICATIONS

This application claims the benefit of U.S. provisional Application No. 61/375,572 filed Aug. 20, 2010, the disclosure of which is incorporated in its entirety by reference herein.

### TECHNICAL FIELD

The present invention relates to a computer-based document review system.

### BACKGROUND

Human review of electronic documents permeates civil litigation. Such document reviews usually involve continuous user interaction that may lead to user discomfort as well as ailments related to repetitive user movements. Accordingly, there is a need for improved systems for reviewing electronic documents.

### SUMMARY

The present invention solves one or more problems of the prior art by providing in at least one embodiment a computer implemented system for reviewing documents from an ordered list of electronic documents. The system comprises a computer processor implementing a method including sequentially displaying documents from the ordered list of documents on a monitor. The documents are viewed by automatically displaying pages from a user selected document in the ordered list in a page-by-page manner. After display of the last page of the user selected document, pages from the next document are automatically displayed in the ordered list in a page-by-page manner. This process is continued until a predetermined stop word is contained on a presented page or a stop command is received from the user. The method further comprises sequentially displaying pages from subsequent documents in the ordered list in a page-by-page manner.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic of a computer system for reviewing a list of documents;

FIG. 2 is a flowchart illustrating a computer implemented method for reviewing documents;

FIG. 3 is a screenshot of a window interface used to display documents to a user;

FIG. 4 is a screenshot of an interface showing an ordered list of documents contained within a directory;

FIG. 5 is a screenshot of a window interface showing textboxes into which the user definable labels are entered;

FIG. 6 is a screenshot of a window interface used to enter and/or display document related metadata;

FIG. 7 is a screenshot of an interface used to perform a search and display an ordered list of search results; and

FIG. 8 is a screenshot of an interface used to display search results with hits highlighted.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

In an embodiment of the present invention, a computer implemented system for reviewing documents from an ordered list of documents is provided. In one variation, the ordered list is a listing of documents in a directory ordered alphabetically or numerically. In another variation, the order list is a listing of files found by a search engine. Such search engine results may be ordered alphabetically, numerically, by the total number of hits, and the like. The present embodiment is particularly useful for reviewing documents in Adobe's PDF format as well as image formats such as tagged image format (TIF), bitmap (BMP), jpeg files and the like. With respect to the image formats, there is typically an associated text containing file.

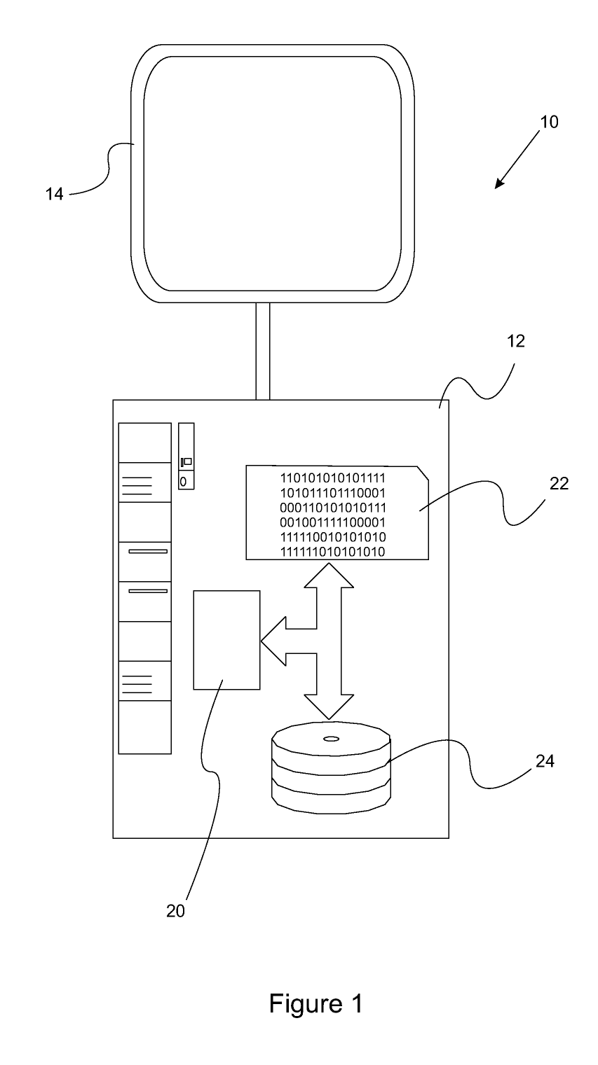

With reference to FIG. 1, a schematic of a computer system for reviewing a list of documents is provided. System 10 comprises computer 12 implementing a method including sequentially displaying documents from the ordered list of documents on monitor 14. Computer 12 includes computer processor 20, random access memory 22, and storage medium 24. Typically, the instructions for implementing the method of the present embodiment are encoded onto storage medium 24. During operation, the instructions are typically loaded into memory 22 and then transferred to processor 20 during execution.

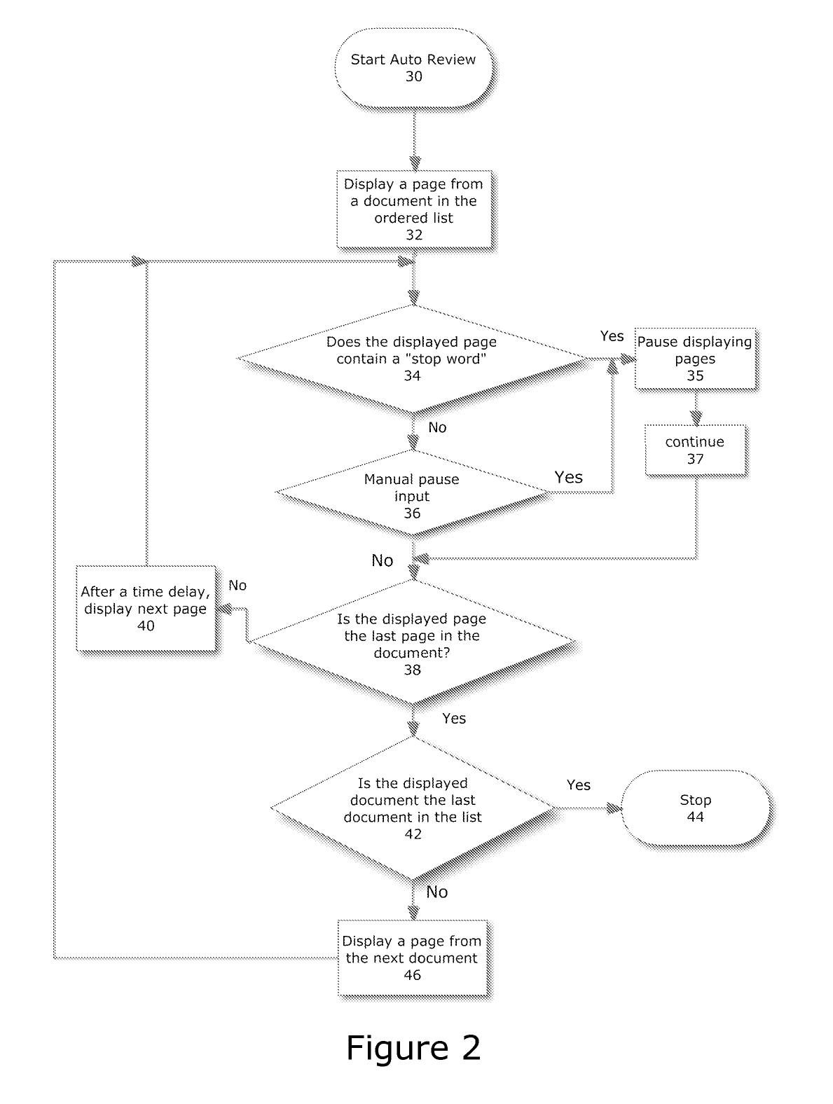

With reference to FIG. 2, a flowchart illustrating the method implemented by computer 12 is provided. As set forth in Box 30, the system receives a start command from a user to display a document from an ordered list of documents. A page from the selected document is displayed (Box 32). In a refinement, the displayed page is the first page of the document. Pages are automatically displayed from the selected document in a page-by-page manner (i.e., sequentially displayed). In the present context, “automatically displaying” means that upon receiving the start command from a user, the system displays pages and documents without further input from the user. In a refinement, each page of the first document is displayed for a time interval that is less than a predetermined maximum time interval. Sequential displaying of pages proceeds as follows. As set forth in Box 34, the system determines if the displayed page has a “stop word” on it. Stop words are words entered by the user. These are words that the user wishes the system to pause on (Box 35). The user may also stop the automatic page presentation by entering a stop command as set forth in Box 36. In either instance, the page-by-page presentation is resumable by an appropriate user input (Box 37). At Box 38, the system determines if the displayed page is the last page of the displayed document. If the page is not the last page, the next page of the document is displayed (Box 40). The system determines if the displayed document is the last document of the ordered list (Box 42). If the document is the last document, the system stops the automatic page displaying method (Box 44). If the document is not the last document in the list, a page from the next document is displayed (Box 46). Typically, the first page is displayed. The system then iteratively loops back to the step of Box 34.

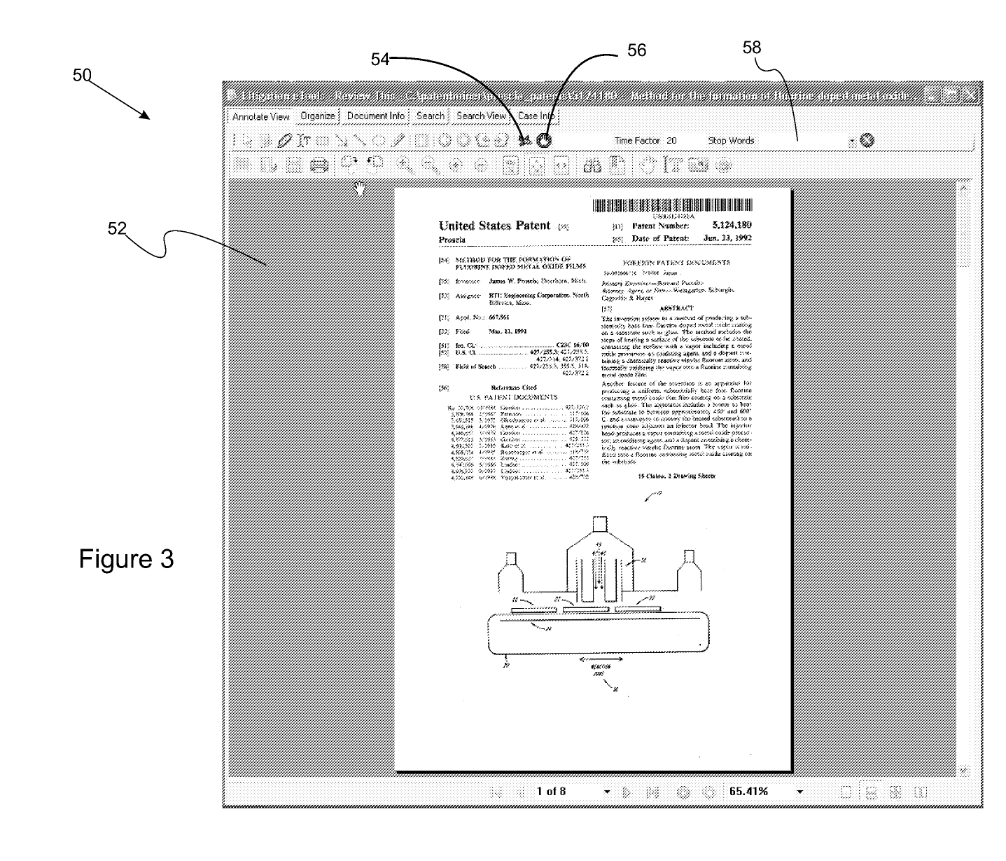

With reference to FIG. 3, a screenshot of a window interface used to display documents to a user is provided. User interface 50 displays documents via file viewer 52. In the case of PDF documents, a suitable file viewer is the Foxit PDF SDK ActiveX control commercially available from Foxit Corporation located in Fremont, Calif. Automatic displaying of documents is commenced by the user clicking on button 54 and stopped by the user clicking on button 56. Stop words are entered into list 58.

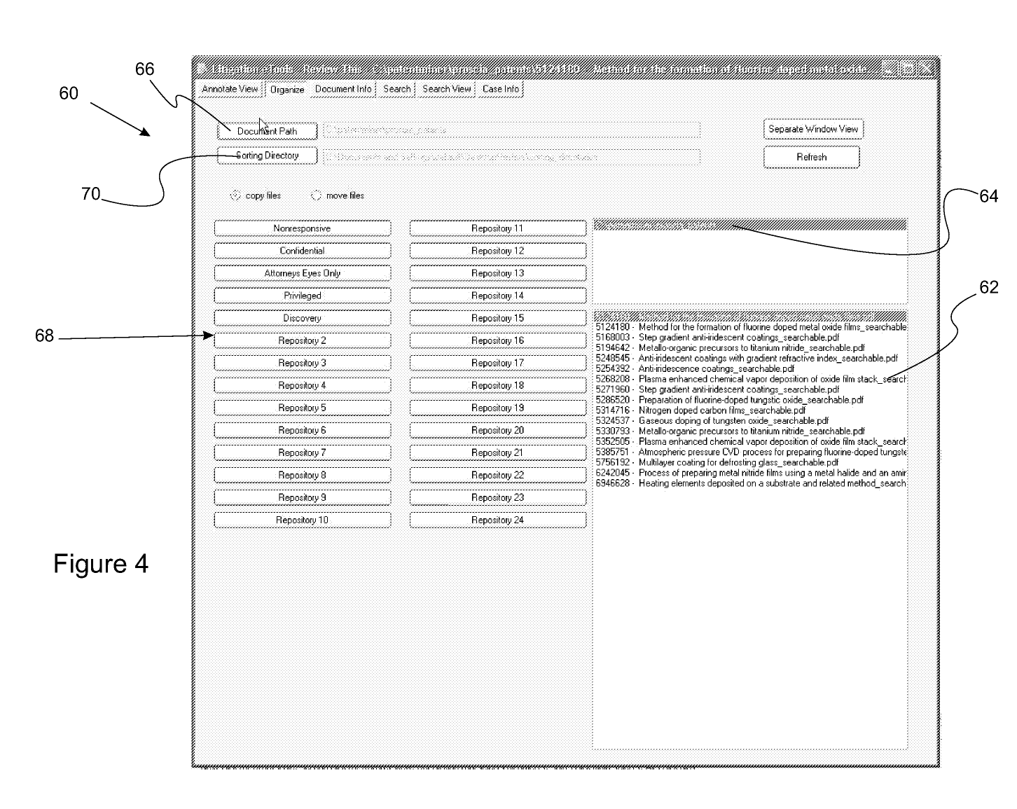

With reference to FIG. 4, a screenshot of a window interface showing an ordered list of documents is provided. User interface 60 includes listing 62 of documents contained within directory 64. The directory is user selectable via button 66 and its related dialog box. FIG. 4 also provides a set of buttons 68 that are used by the user to sort documents. In this latter refinement, a plurality of predefined sorting labels is provided. In another variation, a plurality of buttons with user defined labels is provided. In FIG. 4, the user definable labels start with “Repository.” In each instance, the displayed document is either copied or moved to a directory corresponding to the button selected by the user. A root directory for sorting documents is set by button 70 and its related dialog box.

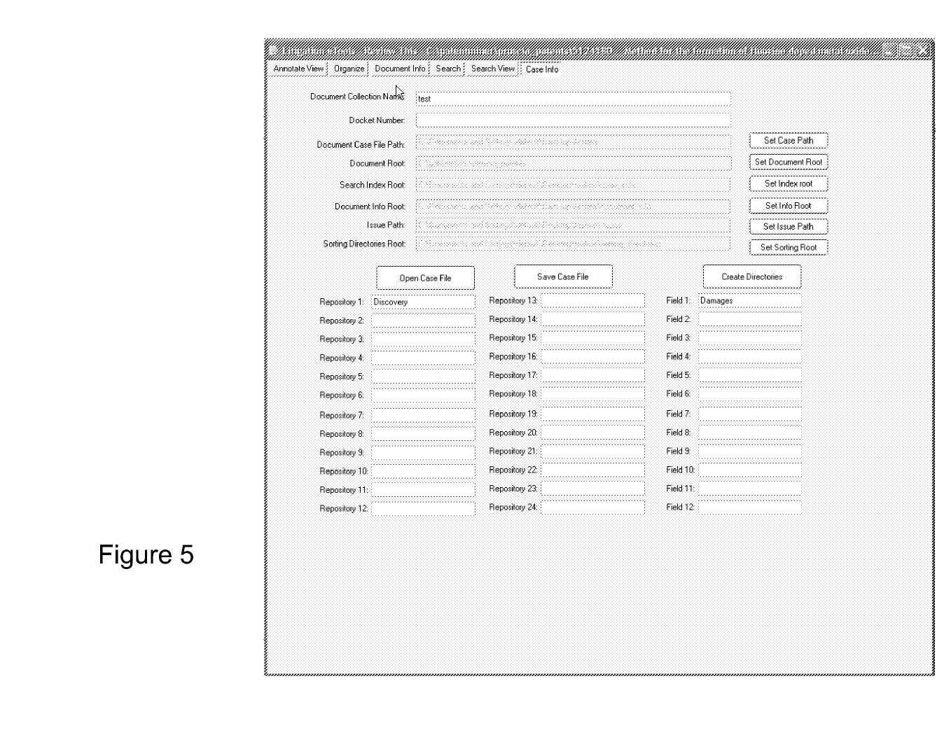

FIG. 5 provides a screenshot of a window interface showing textboxes into which the user definable labels are entered. Notice that the name of “Repository 1” is changed to “Discovery.”

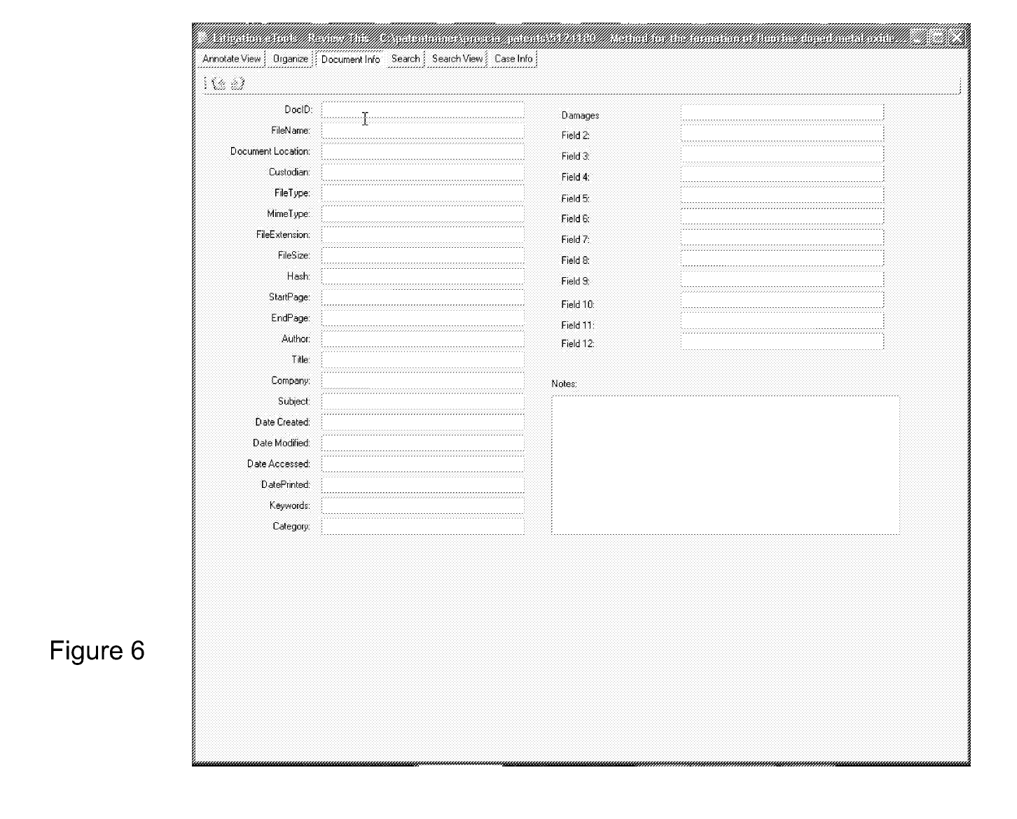

With reference to FIG. 6, a screenshot of a window interface used to enter and/or display document related metadata is provided.

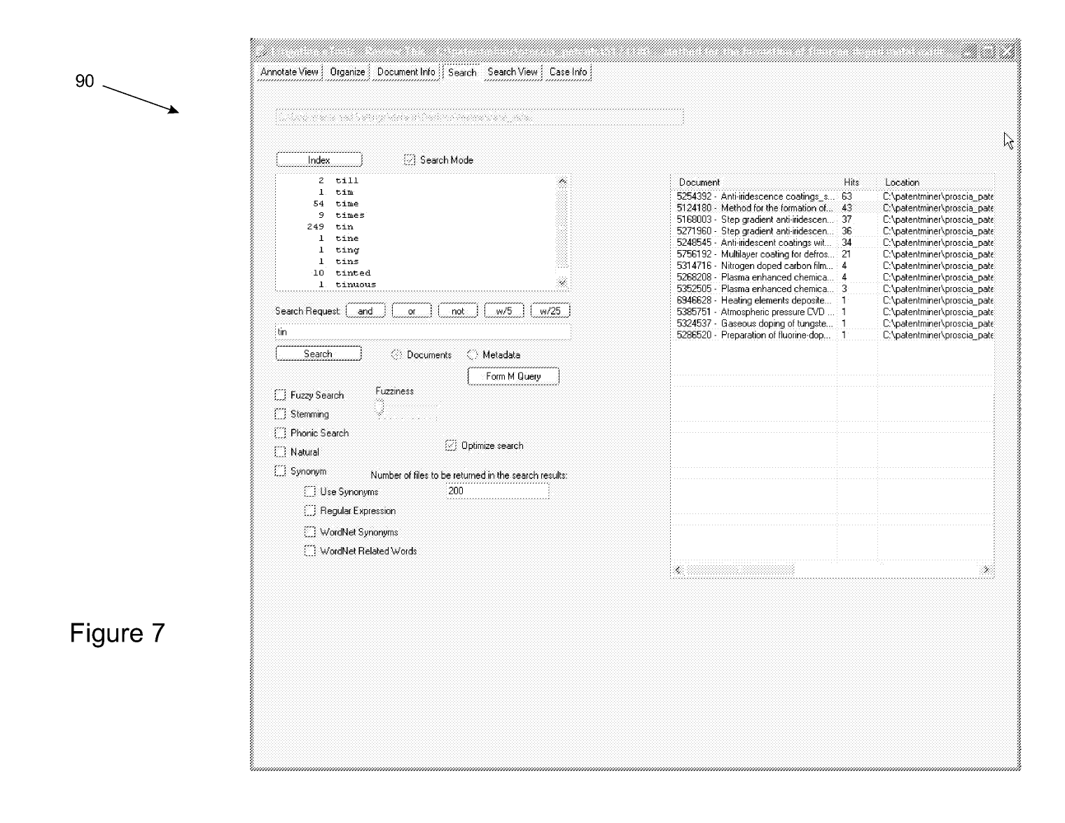

FIG. 7 is a screenshot of an interface used to perform a search and to display an ordered list of search results. User interface 90 includes textbox 92 into which a user enters terms to be searched in a collection of documents. The search results are displayed in list 92. The search results are sequentially displayed in the manner set forth above. A useful searching component is commercially available from dtSearch Corp. located in Bethesda, Md.

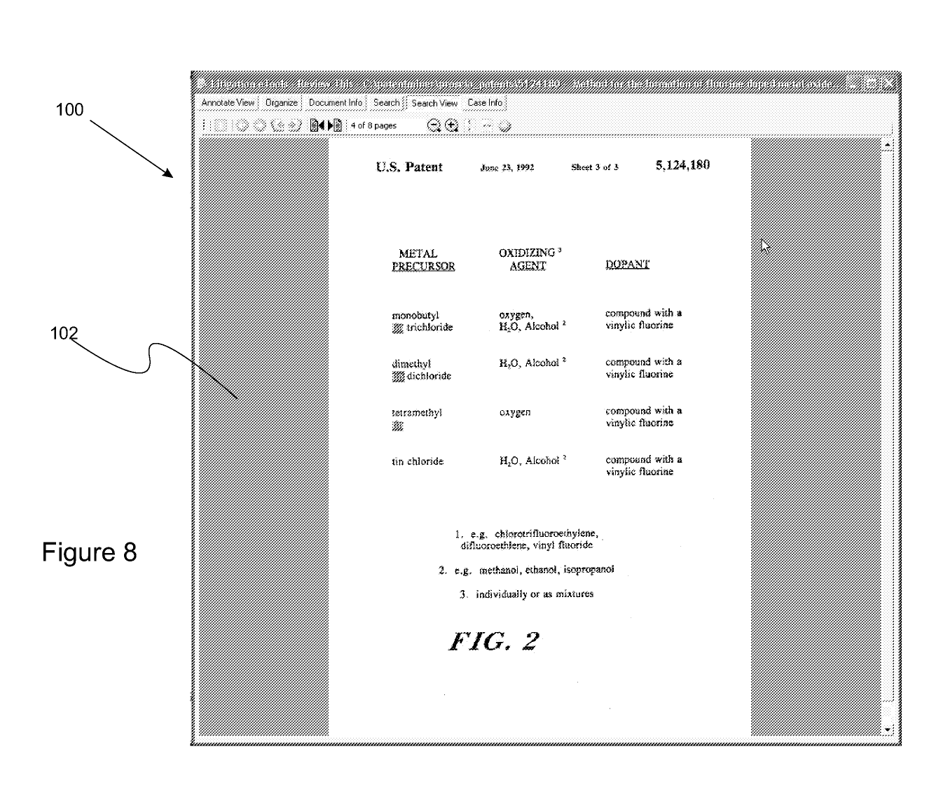

FIG. 8 is a screenshot of an interface used to display search results with hits highlighted. Interface 100 includes document viewer 102 which displays documents with highlighted search results. In the case of a PDF document, a useful viewer is the XpdfViewer® ActiveX Control commercially available from Glyph & Cog, LLC located in Cupertino, Calif.

An embodiment of the present invention is provided by the following c# program. The attached code also provides additional functionality. For example, interfaces for selecting and indexing directories to be used by the search engine are provided. The program also provides the ability to create user defined issues with each issue linking to a set of relevant documents. In a variation of this embodiment, a non-transitory computer readable medium (e.g., CDROM, DVD, optical disk, hard drive, etc) having steps encoded thereon for performing the method set forth above such as the c# program is provided.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for reviewing documents from an ordered list of documents, the system comprising a computer processor implementing a method comprising:
sequentially displaying documents from the ordered list of documents on a monitor by;
automatically displaying pages from a selected document in the ordered list in a page-by-page manner;
after display of the last page of the selected document, automatically displaying pages from the next document in the ordered list in a page-by-page manner; and
ceasing page presentation when a predetermined stop word is contained on a displayed page.

2. The system of claim 1 wherein the method further comprises sequentially displaying pages from subsequent documents in the ordered list in a page-by-page manner.

3. The system of claim 1 wherein each page of a displayed document is displayed for a time interval that is less than the predetermined maximum time interval.

4. The system of claim 1 wherein the method further comprises ceasing page presentation when a user inputs a stop command.

5. The system of claim 1 wherein pages of a document are displayed within a user interface that receives instructions from a user.

6. The system of claim 1 wherein the ordered list is generated from search engine results.
